(19) United States
(12) Patent Application Publication
(10) Pub. No.: US 2017/0363315 A1
(43) Pub. Date: Dec. 21, 2017

(54) HEAT SOURCE SYSTEM OPERATION MANAGEMENT APPARATUS, HEAT SOURCE SYSTEM OPERATION MANAGEMENT METHOD AND COMPUTER PROGRAM

(71) Applicant: HITACHI, LTD., Tokyo (JP)

(72) Inventors: Kaoru KAWABATA, Tokyo (JP); Tsutomu KAWAMURA, Tokyo (JP); Ryousuke NAKAMURA, Tokyo (JP); Hiroshige KIKUCHI, Tokyo (JP); Susumu IKEDA, Tokyo (JP)

(73) Assignee: HITACHI, LTD., Tokyo (JP)

(21) Appl. No.: 15/543,769

(22) PCT Filed: Jan. 20, 2016
(86) PCT No.: PCT/JP2016/051486

§ 371 Date: Jul. 14, 2017

(30) Foreign Application Priority Data
Feb. 4, 2015 (JP) 2015-019958

(51) Int. Cl. F24F 11/02; F24F 3/08; G05B 19/048; F24F 5/00

(52) U.S. Cl. CPC F24F 11/02; G05B 19/048; F24F 3/08; F24F 2005/0025; G05B 2219/2614

(57) ABSTRACT

An operation management apparatus includes: a refrigerant return temperature prediction unit that predicts a temperature Tr of a refrigerant returning from an air conditioner to a heat source system; a heat storage capacity estimation unit that estimates a heat storage capacity of the heat source system, based on the predicted refrigerant return temperature Tr; and an operation plan unit that creates a plan based on the estimated heat storage capacity. The heat source system includes: a storage tank that supplies the refrigerant to the air conditioner; a refrigerant generation unit that cools the refrigerant returning from the air conditioner via the storage tank, and supplies it to the storage tank; a refrigerant feed temperature detection unit that measures a temperature of the refrigerant from the refrigerant generation unit; and a refrigerant return temperature detection unit that measures a temperature of the refrigerant returning from the storage tank.

### TECHNICAL FIELD

The present invention relates to a heat source system operation management apparatus, a heat source system operation management method, and a computer program.

### BACKGROUND ART

In recent years, influence on environment due to power shortage associated with an increase in energy consumption and an increase in greenhouse gas emission has been a problem. For that reason, efforts of efficient energy use to realize energy saving and CO2 emission reduction have been progressed. As one of the measures, there is utilization of a heat source system including a heat storage tank. The heat storage tank of the heat source system supplies heat stored in advance to an air conditioner in accordance with fluctuation of a heat load (air conditioning load). A peak of power demand can be shifted by using the heat storage tank during a high heat load time zone.

As a conventional technique relating to the heat source system, a technique has been known for providing a control apparatus that performs optimal operation of the heat source system including the heat storage tank (PTL 1). In the conventional technique according to PTL 1, the heat load is predicted with reference to actual weather data, operation result data, and characteristics of the building, and operation plan data is generated for making maximum use of the heat storage tank from the predicted heat load, and operation of the heat source system is controlled. In the conventional technique, when a difference between a remaining amount of heat storage and the heat load due to a difference between an operation plan and an operation result is out of a predetermined range, the operation plan is reviewed.

In addition, a technique also has been known that reduces an operator's burden and secures stable supply of a heat source and safe operation, and appropriately performs start and stop of the heat source in an emergency (PTL 2). In the conventional technique according to PTL 2, the heat load is predicted based on temperature distribution of the heat storage tank, inlet/outlet temperature of a heat source device, flow rate, measurement value of circulating water temperature, weather information, and day of week information, and a heat storage tank operation plan and a heat source device operation plan are created based on the predicted heat load, and the heat source device is controlled. When a shift occurs between a planned value and an actual value due to accumulation of prediction errors, the operation plan is corrected.

### CITATION LIST

### Patent Literature

PTL 1: JP 2008-82642 A

PTL 2: JP H5-88715 A

### SUMMARY OF INVENTION

### Technical Problem

In the conventional technique, during creation of an operation plan for storing/releasing heat to/from the heat source device, the plan is created based on a predetermined heat storage capacity (it is also an amount of releasable heat. The same applies to the following). The heat storage capacity is determined by a heat storage tank capacity, a cold water feed temperature (set value) from the heat source device such as a chiller, and a cold water return temperature from a consumer side (such as an air conditioner). In the conventional technique, either of a design value, or a cold water return temperature measured at the time of operation planning is used as the cold water return temperature, and the heat storage capacity is evaluated with the cold water return temperature.

However, depending on seasons, weather conditions, and the like, the cold water return temperature during heat release differs from the design value (assumed value) or actual measured temperature at the time of operation planning, in many cases. When the cold water return temperature changes outside an assumed range, the heat storage capacity also differs, so that an appropriate operation plan cannot be created.

For example, when an actual cold water return temperature is lower than the assumed value, the heat storage capacity has been overestimated, so that an amount of cold heat to be supplied during heat release becomes insufficient. Conversely, when the actual cold water return temperature is higher than the assumed value, the heat storage capacity has been underestimated, so that the amount of cold heat becomes in excess.

The present invention has been made in view of the above problem, and it is an object to provide a heat source system operation management apparatus, a heat source system operation management method, and a computer program that are capable of predicting a refrigerant return temperature and estimating a heat storage capacity, to create an appropriate operation plan for a heat source system.

### Solution to Problem

To solve the above problem, a heat source system operation management apparatus according to the present invention is an operation management apparatus for managing operation of a heat source system that supplies a refrigerant to an air conditioner, and the apparatus includes: a refrigerant return temperature prediction unit that predicts a refrigerant return temperature that is a temperature of the refrigerant returning from the air conditioner to the heat source system; a heat storage capacity estimation unit that estimates a heat storage capacity of the heat source system, based on the predicted refrigerant return temperature; and an operation plan creation unit that creates an operation plan for the heat source system, based on the estimated heat storage capacity.

An operation control data creation unit can be further included that creates operation control data for controlling the operation of the heat source system in accordance with the operation plan created by the operation plan creation unit.

The heat source system may include a heat storage tank that supplies the stored refrigerant to the air conditioner; a refrigerant generation unit that cools the refrigerant returning from the air conditioner via the heat storage tank, and supplies the cooled refrigerant to the heat storage tank; a refrigerant feed temperature detection unit that measures and outputs a temperature of the refrigerant fed from the refrigerant generation unit to the heat storage tank; and a refrigerant return temperature detection unit that measures and outputs a temperature of the refrigerant returning from the heat storage tank to the refrigerant generation unit.

### Advantageous Effects of Invention

According to the present invention, it is possible to predict a return temperature of the refrigerant returning from the air conditioner to the heat source system, and estimate the heat storage capacity of the heat source system, based on the predicted refrigerant return temperature, and create the operation plan for the heat source system, based on the estimated heat storage capacity. Thus, the heat stored in the heat storage tank can be efficiently used.

### BRIEF DESCRIPTION OF DRAWINGS

FIG. 1 is an overall configuration diagram including a heat source system and an operation management apparatus.

FIG. 2 is a block diagram of the operation management apparatus.

FIG. 3 is a flowchart of an operation plan creation process.

FIG. 4 is a flowchart of a cold water return temperature prediction process.

FIG. 5 is a configuration example of operation result data.

FIG. 6 is a flowchart of a process of calculating a cold heat unit price.

FIG. 7 is a graph illustrating an example of energy consumption characteristics of a chiller.

FIG. 8 is a graph illustrating time change of a power unit price.

FIG. 9 illustrates an example of an operation plan.

### DESCRIPTION OF EMBODIMENTS

Hereinafter, an embodiment of the present invention is described with reference to the drawings. In the present embodiment, a description is made where water is used as a refrigerant, as an example. Further, in the present embodiment, the description is made where an air conditioner 3 is caused to perform cooling operation, as an example. However, the present embodiment can be applied not only to a case of cooling operation, but also to a case of heating operation.

A heat source system operation management apparatus 1 of the present embodiment predicts a cold water return temperature that meets conditions at a scheduled heat release time on an operation plan date, based on previous operation result data 102 (season, date and time, day of week, environmental conditions such as temperature, humidity and weather, amount of cold heat, cold water return temperature), in a heat source system 2 that provides cold water to a plurality of the air conditioners 3, as described in detail below. The heat source system operation management apparatus 1 estimates a heat storage capacity (amount of releasable heat), based on the predicted cold water return temperature, and creates an operation plan (heat storage and heat release plan) of a heat source device 22, based on the estimated heat storage capacity.

Further, the heat source system operation management apparatus 1 creates operation control data for controlling a chiller 22 as the heat source device, based on the created operation plan. The heat source system operation management apparatus 1 can also include an apparatus 13 for referring to the operation plan and a creation result of the operation control data. Further, the heat source system operation management apparatus 1 stores result data of the chiller 22 as the operation result data, and utilizes the result data for a prediction process of cold water return temperature on a later date.

According to the present embodiment thus configured, in the heat source system 2 including a heat storage tank 20, it is possible to estimate the heat storage capacity corresponding to the fluctuating cold water return temperature, and create the optimal operation plan to appropriately control the chiller 22. Thus, energy saving operation can be achieved, and an operation cost can be reduced.

### Example 1

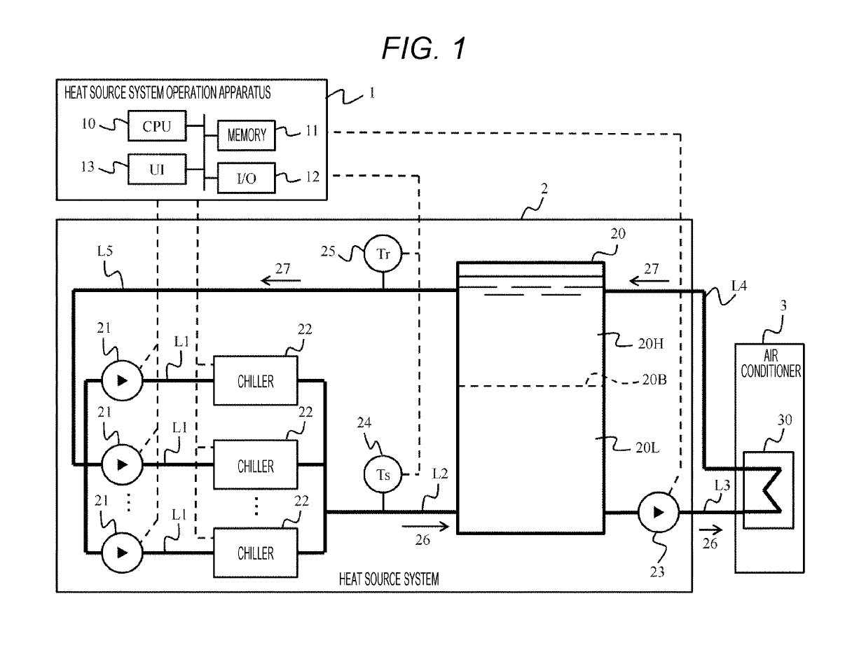

An example is described with reference to FIG. 1 to FIG. 9. FIG. 1 illustrates an overall configuration example of an energy network system including the heat source system 2 and the operation management apparatus 1.

The energy network system includes the heat source system operation management apparatus 1 (hereinafter, the operation management apparatus 1), the heat source system 2, and at least one air conditioner 3. As described above, here, a case is described where cold water is supplied to the air conditioner 3 for cooling.

A configuration of the heat source system. 2 is described. The heat source system 2 includes, for example, the heat storage tank 20, a primary side water feed pump 21, the chiller 22 that is the heat source device, a secondary side water feed pump 23, a cold water feed temperature detection unit 24, a cold water return temperature detection unit 25, and piping L1, L2, L3, L4, L5.

A discharge port of each of a plurality of the primary side water feed pumps 21 is connected to the chiller 22 via the first piping L1. Each chiller 22 is an example of the heat source device, and corresponds to a “refrigerant generation unit.” The cold water generated by each chiller 22 is supplied to the heat storage tank 20 via the second piping L2.

The heat storage tank 20 is configured as a single temperature stratified heat storage tank, for example. In the heat storage tank 20, two layers 20L, 20H are formed depending on a density difference of the cold water. One layer is the low temperature portion 20L in which cold water 26 with relatively low temperature from each chiller 22 is positioned. The other layer is the high temperature portion 20H in which cold water 27 with relatively high temperature returning from the air conditioner 3 is positioned.

The cold water 26 of the low temperature portion 20L of the heat storage tank 20 is fed to a heat load apparatus 30 in the air conditioner 3 via the third piping L3 by the secondary side water feed pump 23. The cold water 27 warmed by heat exchange by the heat load apparatus 30 returns to the high temperature portion 20H of the heat storage tank 20 via the fourth piping L4.

The cold water 27 of the high temperature portion 20H of the heat storage tank 20 is fed to a suction port of each primary side water feed pump 21 via the fifth piping L5. As described above, the cold water 27 with high temperature is fed to the chiller 22 and its temperature is decreased, and supplied to the heat storage tank 20 as cold water with low temperature. In this way, the heat source system 2 circulates the cold water stored in the heat storage tank 20 with the air conditioner 3. A temperature boundary 20B between the low temperature portion 20L and the high temperature portion 20H of the heat storage tank 20 fluctuates depending on an operation condition of the heat source system 2.

In the middle of the second piping L2 that connects each chiller 22 and the heat storage tank 20 together, the cold water feed temperature detection unit 24 is provided to measure a temperature Ts of the cold water 26 supplied from each chiller 22 to the heat storage tank 20 and output the temperature to the operation management apparatus 1. In the middle of the fifth piping L5 that connects the heat storage tank 20 and each primary side water feed pump 21 together, the cold water return temperature detection unit 25 is provided to measure a temperature Tr of the cold water 27 supplied from the heat storage tank 20 via each primary side water feed pump 21 to each chiller 22 and output the temperature to the operation management apparatus 1. An installation position of each of the temperature detection units 24, 25 is not limited to the example illustrated in FIG. 1.

Further, in FIG. 1, three primary side water feed pumps 21 and three chillers 22 are illustrated; however, not limited thereto, the number of each of the primary side water feed pumps 21 and the chillers 22 may be one, two, or four or more. The number of the primary side water feed pumps 21 and the number of the chillers 22 do not need to match each other. The heat source system 2 can supply the cold water to the plurality of air conditioners 2, and each air conditioner 3 can include a plurality of the heat load apparatus 30.

As described above, in the heat storage tank 20, there are the low temperature portion 20L including low temperature cold water with low temperature and a high density, and the high temperature portion 20H including high temperature cold water with high temperature and a low density. When the low temperature cold water 26 is fed into the heat storage tank 20 to store heat, a region of the low temperature portion 20L increases, and the temperature boundary 20B rises. When the low temperature cold water 26 is discharged from the heat storage tank 20 to release heat, the region of the low temperature portion 20L decreases, and the temperature boundary 20B falls.

The operation management apparatus 1 is an apparatus for controlling cold water supply by the heat source system 2, and configured as a computer apparatus including a microprocessor unit 10, a memory unit 11, an input/output unit 12, and a user interface unit 13, for example.

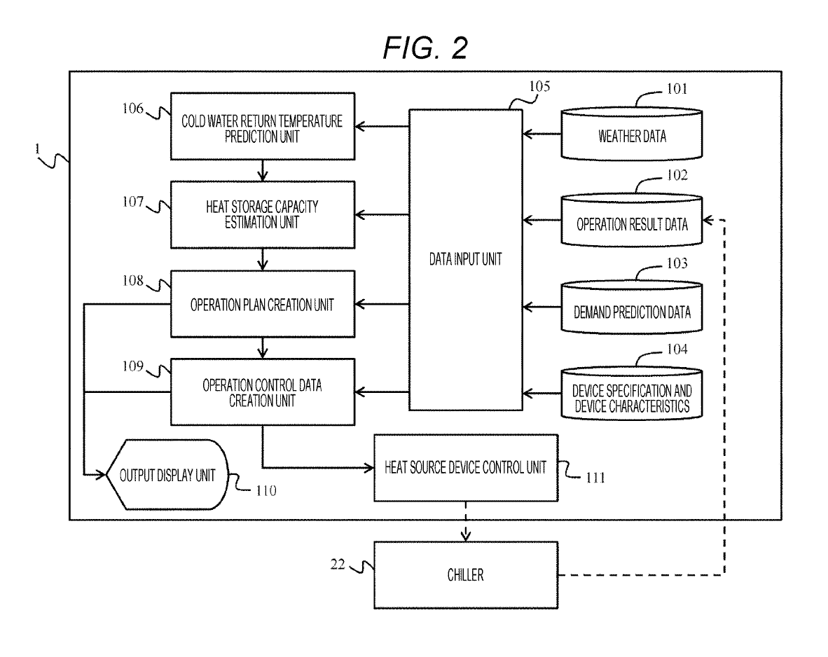

The memory unit 11 stores predetermined computer programs for implementing functions 106, 107, 108, 109 described later in FIG. 2. The microprocessor unit 10 reads and executes those computer programs to implement the functions 106 to 109.

The input/output unit 12 is an apparatus for electrically connecting the operation management apparatus 1 and the heat source system 2 to each other. The user interface unit 13 is an apparatus for exchanging information with a user (for example, a system administrator) that manages the operation management apparatus 1. The user interface unit 13 includes an information input apparatus for the user to input the information into the operation management apparatus 1, and an information output apparatus for providing the information from the operation management apparatus 1 to the user. Examples of the information input apparatus include a keyboard, a mouse, a touch panel, a voice input apparatus, and a line-of-sight detection apparatus. Examples of the information output apparatus include a display, a printer, and a voice synthesis apparatus. Incidentally, the operation management apparatus 1 can also provide the information to the user by using an e-mail or the like.

The operation management apparatus 1 is electrically connected via the input/output unit 12 to each primary side water feed pump 21, each chiller 22, the secondary side water feed pump 23, and each of the temperature detection units 24, 25. The operation management apparatus 1 receives a temperature signal measured by each of the temperature detection units 24, 25, and creates operation control data according to the operation plan, to control each primary side water feed pump 21, each chiller 22, and the secondary side water feed pump 23.

Here, a primary side amount of cold heat Q1 to be supplied from each chiller 22 to the heat storage tank 20, a secondary side amount of cold heat Q2 to be supplied from the heat storage tank 20 to the air conditioner 3, an amount of heat storage Qs to the heat storage tank 20, and an amount of heat release Qr from the heat storage tank 20 are given as follows.

Q1=ρ·C·W1·(Tr−Ts) [Formula 1]

Q2=ρ·C·W2·(Tr−Ts) [Formula 2]

Q1=Q2+Qs [Formula 3]

Therefore, when Q1>Q2, the amount of heat storage is Qs (Qs=Q1−Q2).

Q2=Q1+Qr [Formula 4]

Therefore, when Q2>Q1, the amount of heat release is Qr (Qr=Q2−Q1).

In the above formulas, ρ [kg/m3] is a density of the cold water, and C [J/(kg·° C.)] is a specific heat of the cold water. Tr [° C.] is the cold water return temperature, Ts [° C.] is the cold water feed temperature, W1 [m3/s] is a primary side flow rate (a water feed flow rate from the chiller 22 to the heat storage tank 20), W2 [m3/s] is a secondary side flow rate (a water feed flow rate from the heat storage tank 20 to the air conditioner 3).

The operation management apparatus 1 uses the predicted cold water return temperature Tr, the estimated heat storage capacity, weather data such as a temperature and a humidity by a weather forecast for an operation target date of the chiller 22 that is the heat source device, and demand prediction data of the amount of cold heat relating to the air conditioner 3 and the like, to create an operation plan, and controls driving of the chiller 22 and the like in accordance with the operation plan, as described later.

FIG. 2 is a block diagram illustrating a system configuration example of the operation management apparatus 1. The operation management apparatus 1 includes a weather data management unit 101, an operation result data management unit 102, a demand prediction data management unit 103, a device specification and device characteristics data management unit 104, a data input apparatus 105, a cold water return temperature prediction unit 106, a heat storage capacity (amount of releasable heat) estimation unit 107, an operation plan creation unit 108, an operation control data creation unit 109, an output display unit 110, and a heat source device control unit 111, for example.

The weather data management unit 101 is configured to be capable of using weather forecast data delivered by, for example, Japan Meteorological Agency or a weather forecast service company, and manages the weather forecast on a target date of the operation plan. The weather forecast includes temperature and humidity, for example. If necessary, an amount of solar radiation, a wind speed, and a wind direction may be included. Hereinafter, the data managed by the weather data management unit 101 may be referred to as weather data 101.

The operation result data management unit 102 manages the operation result data of the chiller 22 that is the heat source device in the heat source system 2, and each apparatus relating to the heat storage tank 20 and the air conditioner 3. The operation result data is configured to associate the measurement date and time and the like with measurement values such as the amount of cold heat, the temperature, the humidity, and the flow rate relating to the chiller 22, the heat storage tank 20, the air conditioner 3, and the like, for example. Hereinafter, the data managed by the operation result data management unit 102 may be referred to as operation result data 102.

The demand prediction data management unit 103 manages the demand prediction data predicting the amount of cold heat and the like in a demand side such as the air conditioner 3. Hereinafter, the data managed by the demand prediction data management unit 103 may be referred to as demand prediction data 103.

The device specification and device characteristics data management unit 104 manages device specification and device characteristics data relating to the chiller 22 and the heat storage tank 20. The device characteristics include energy consumption characteristics, and a power unit price, for example. Hereinafter, the data managed by the device specification and device characteristics data management unit 104 may be referred to as device specification and device characteristics data 104.

The data input unit 105 is a function that takes in the data of each of the data management units 101, 102, 103, 104 described above, and provides the data to each of the process units 106, 107, 108, 109.

The cold water return temperature prediction unit 106 is a function that uses the weather data 101 and the operation result data 102 to predict the cold water return temperature at a scheduled heat release time on an operation plan target date. In the following description, the operation plan target date may be referred to as an operation plan date, and the scheduled heat release time may be referred to as a heat release time.

The heat storage capacity estimation unit 107 is a function that uses the cold water return temperature predicted by the cold water return temperature prediction unit 106, and the device specification and device characteristics data 104, to estimate the heat storage capacity (amount of releasable heat) required during operation control based on the operation plan.

The operation plan creation unit 108 is a function that uses the estimated heat storage capacity, the demand prediction data 103, and the device specification and device characteristics data 104, to create the operation plan for heat storage or heat release on the operation plan target date. The operation control data creation unit 109 is a function that uses the created operation plan and the device specification and device characteristics data 104, to create the data for controlling driving of the chiller 22 as the heat source device. Incidentally, during operation control of the chiller 22, it is necessary to control the water feed pumps 21, 23, and the like. Here, it is described assuming that control data relating to those additional apparatuses are also included in the operation control data.

The output display unit 110 is a function generated by using the user interface unit 13, and displays the operation plan created by the operation plan creation unit 108, the operation control data created by the operation control data creation unit 109, a result of the operation plan, and the like. The heat source device control unit 111 is a function that outputs the operation control data created by the operation control data creation unit 109 to the chiller 22 that is a control target, and is generated by using the input/output unit 12.

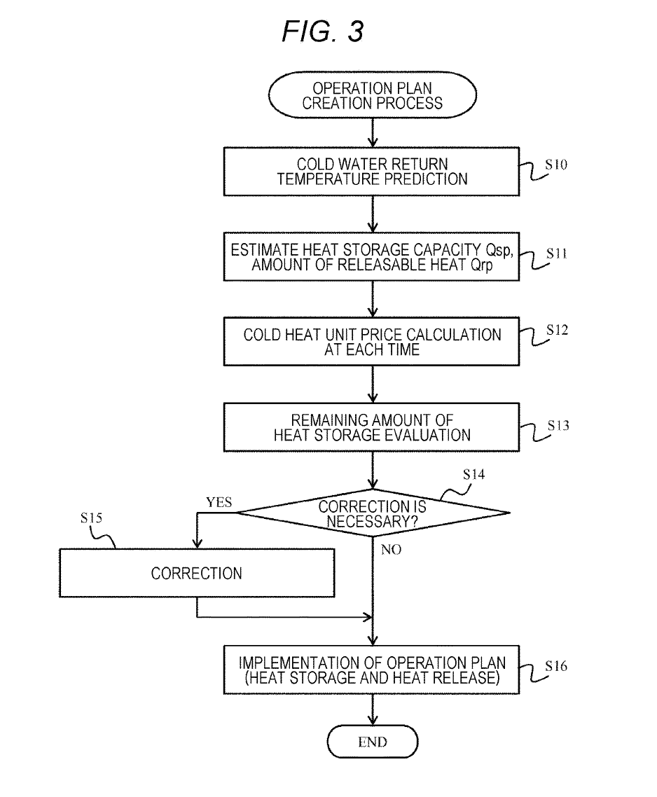

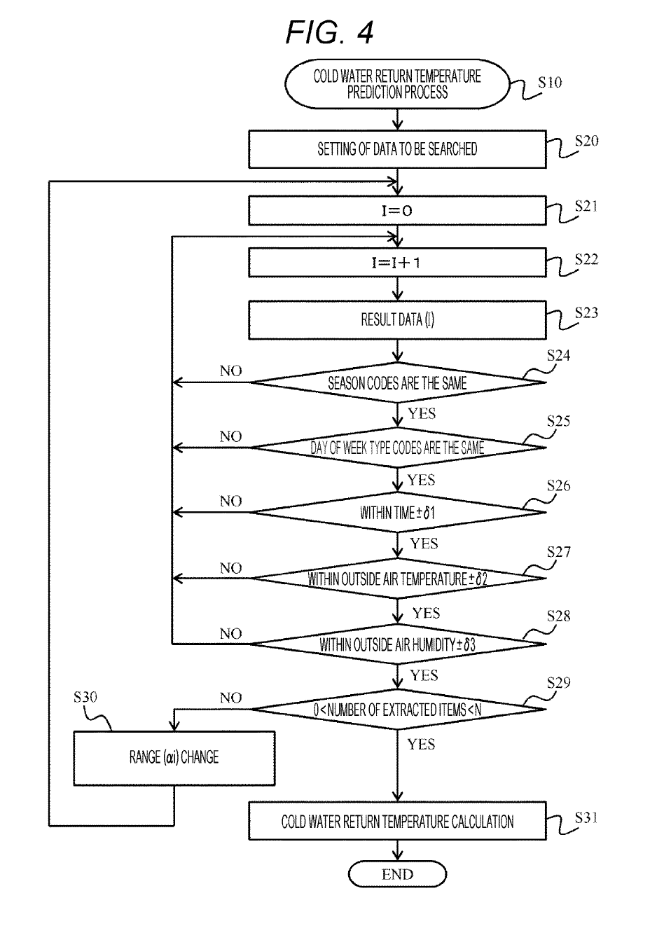

FIG. 3 is a flowchart illustrating a process of creating the operation plan. The cold water return temperature prediction unit 106 of the operation management apparatus 1 predicts the cold water return temperature at the scheduled heat release time on the operation plan target date, based on the weather data 101 and the operation result data 102 (S10). A prediction procedure of the cold water return temperature is described later with reference to FIG. 4.

The heat storage capacity estimation unit 107 estimates a heat storage capacity Qsp and an amount of releasable heat Qrp of the heat storage tank 20 at the time of operation planning, based on the predicted cold water return temperature (S11). “At the time of operation planning” means when the operation control of the heat source system 2 is performed in accordance with the operation plan.

The heat storage capacity Qsp and the amount of releasable heat Qrp are given by Formula 5. In Formula 5, V [m3/s] is a capacity of the heat storage tank 20.

Qsp=Qrp=ρ·C·V·(Tr−Ts) [Formula 5]

The operation plan can be divided into a heat storage plan for storing heat for the heat storage capacity in the heat storage tank 20, and a heat release plan for releasing heat for the amount of releasable heat from the heat storage tank 20. In the heat storage plan, heat is stored using nighttime power that is inexpensive. For this reason, for the heat storage plan, a time zone in which a cold heat unit price is low is set in a period from 0:00 to 8:00, for example. On the other hand, in the heat release plan, a time zone in which the chiller 22 is operated and the air conditioner 3 is used is set. For example, in a period from 8:00 to 24:00, a higher charge time at which the cold heat unit price is high is set for the heat release plan.

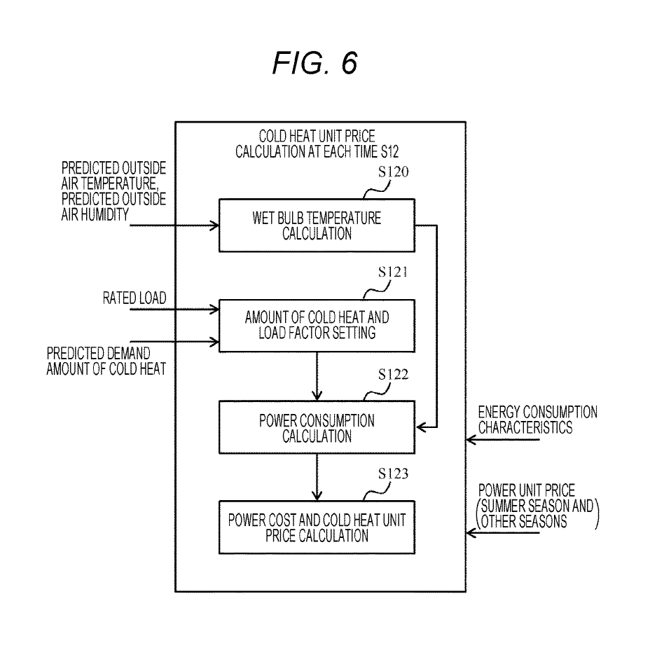

The operation plan creation unit 108 uses the weather data 101, the demand prediction data 103, and the device specification and device characteristics data 104, to calculate the cold heat unit price of a scheduled heat storage time (in the heat release plan, the scheduled heat release time) (S12). A calculation procedure of the cold heat unit price is described later with reference to FIG. 6.

The operation plan creation unit 108 evaluates a remaining amount of heat storage before execution of the operation plan (S13), and determines whether or not it is necessary to correct the heat storage capacity Qsp and the amount of releasable heat Qrp that are estimated in step S11, based on the evaluated remaining amount of heat storage (S14).

There may be a case where the chiller 22 has operated or the air conditioner 3 has operated before the time at which execution of the operation plan is scheduled. In this case, heat that has not been assumed in step S11 has been stored in the heat storage tank 20, or heat release that has not been assumed in step S11 has already been performed. Therefore, there is a possibility that an error occurs in an estimation result in step S11.

Therefore, the operation plan creation unit 108 evaluates the remaining amount of heat storage, based on the operation result data 102 (S13), and determines whether or not correction is necessary for the estimation result in step S11 (S14). The operation plan creation unit 108, when determining that correction is necessary (S14: YES), corrects the heat storage capacity or the amount of releasable heat (S15), and implements the operation plan (S16), and then ends the present process.

On the other hand, the operation plan creation unit 108, when determining that correction is not necessary (S14: NO), implements the operation plan without correcting the heat storage capacity or the amount of releasable heat (S16), and then ends the present process.

When the heat storage plan is corrected, operation time of the chiller 22 is allocated until the set heat storage capacity is reached, in order of the time at which the cold heat unit price is low. Thus, the heat produced in the time zone in which the electricity price is low can be stored in the heat storage tank 20 for the heat storage capacity. When the heat release plan is corrected, operation stop time of the chiller 22 is allocated until the set amount of releasable heat is reached, in order of the time at which the cold heat unit price is high. Thus, the heat of the heat storage tank 20 can be released in the time zone in which the electricity price is high, and operation of the chiller 22 can be stopped to reduce the electricity bill.

FIG. 4 is a flowchart illustrating an example of a process of predicting the cold water return temperature described in step S10 in FIG. 3. The cold water return temperature prediction unit 106 sets data for searching data necessary for predicting the cold water temperature from the operation result data 102 (S20). Specifically, the cold water return temperature prediction unit 106 sets the date and time, predicted outside air temperature, predicted outside air humidity, and the like relating to the operation plan date that is a prediction target for the cold water return temperature, as data to be searched. The data to be searched can also be referred to as a search condition or an operation result data extraction condition.

The cold water return temperature prediction unit 106 initializes a variable I for switching a data search range (S21), and increments the variable I by one (S22). The cold water return temperature prediction unit 106 searches the operation result data 102 within the search range (S23), and extracts the data that meets all the following extraction conditions (S24 to S28). Inspection order of each of the extraction conditions does not matter.

A first extraction condition is whether or not a season code to which the extracted operation result data 102 belongs and a season code to which the operation plan target date belongs are the same as each other (S24). The codes are set for each season beforehand, such as the season code “1” for from January to March, the season code “2” for from April to June, the season code “3” for from July to September, and the season code “4” for from October to December, for example.

A second extraction condition is whether or not a day of week code of the extracted operation result data 102 and a day of week type code of the operation plan target date are the same as each other (S25). The codes are set in advance in accordance with a day of week type, such as the day of week type code “1” for Monday that is the beginning of the week, the day of week type code “2” for from Tuesday to Friday, and the day of week type code “3” for Saturday, Sunday, and national holidays, for example.

A third extraction condition is whether or not an operation time of the extracted operation result data 102 is within the scheduled heat release time plus-minus of [hours “on the operation plan target date (S26).

A fourth extraction condition is whether or not the outside air temperature of the extracted operation result data 102 is within the predicted outside air temperature plus-minus σ2 [ ° C.] at the scheduled heat release time on the operation plan target date (S27).

A fifth extraction condition is whether or not the outside air humidity of the extracted operation result data 102 is within the predicted outside air humidity plus-minus σ3[%] at the scheduled heat release time on the operation plan target date (S28). The above-described σ1, σ2, σ3 are values indicating similarity allowable ranges of parameters under each extraction condition.

The operation result data 102 that meets all of the first to fifth extraction conditions is the data in which the environmental condition is similar to the environmental condition (prediction value) at the scheduled heat release time on the operation plan target date. The operation result data 102 under the similar environmental condition corresponds to “predetermined operation result data.” The predetermined operation result data 102 is useful for predicting the cold water return temperature at the scheduled heat release time on the operation plan target date.

The cold water return temperature prediction unit 106 determines whether or not the number of extracted items of the predetermined operation result data 102 obtained by this search is greater than zero and less than a predetermined upper limit value N (S29). The cold water return temperature prediction unit 106, when determining that the number of extracted items of the predetermined operation result data 102 is one or more and less than N (S29: YES), for example, calculates an average value of those less than N predetermined operation result data 102, to predict the cold water return temperature at the scheduled heat release time on the operation plan target date (S31). Instead of obtaining a simple average value, for example, weighting may be added for each parameter to calculate a weighted average. In addition, the values of the similarity allowable ranges σ1 to σ3 can be changed in accordance with the operation plan target date and the scheduled heat release time, and prediction accuracy specified by the user, for example. The values of the similarity allowable ranges σ1 to σ3 can be changed by reading a fixed value that matches a change condition or a table prepared in advance, or by calculation using a similarity allowable range calculation formula prepared in advance.

The cold water return temperature prediction unit 106, when none of the predetermined operation result data 102 can be extracted or when the upper limit value N or more predetermined operation result data 102 are extracted (S29: NO), changes a search range αi (S30), and returns to step S21 and searches the operation result data 102 again. For example, i varies in a range from 1 to 3.

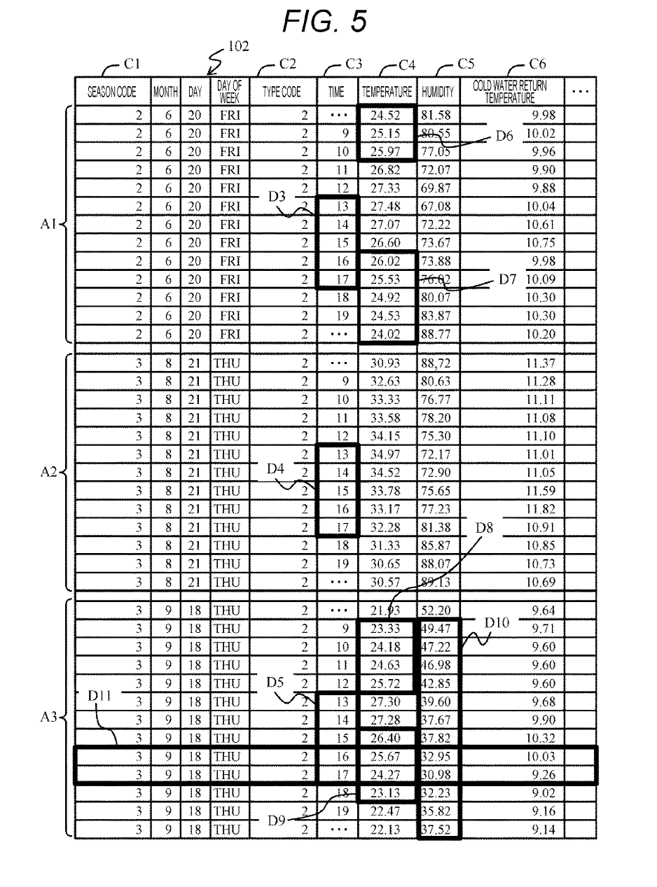

FIG. 5 illustrates an example of the operation result data 102 to be referenced during cold water return temperature prediction described in FIG. 4. Examples of items of the operation result data 102 include a season code C1, a date, a day of week, a day of week type code C2, a time C3, an outside air temperature C4, an outside air humidity C5, and a cold water return temperature C6. The operation result data 102 may include an item other than the items indicated in FIG. 5.

Here, for example, it is assumed that the operation plan target date that is a prediction target for the cold water return temperature is September 25 (Thursday), the predicted heat release time is 15:00, the predicted outside air temperature is 24.5[° C.], the predicted outside air humidity is 40[%], σ1=2 [hours], σ2=1.5[° C.], and σ3=10[%].

The operation result data 102 stores data A1 for previous 24 hours a day for a plurality of days. In a range A1, data in which the season code C1 is “3” (from July to September) are data in a range A2 and data in a range A3, for example. Data in which the day of week type code C2 is “2” (Tuesday to Friday) are data in the ranges from A1 to A3, for example. Among the data in the ranges from A1 to A3, data that match the condition of the season code C1 are data in the ranges A2 and A3.

Data in which the time C3 is a predetermined range (13:00 to 17:00) of the scheduled heat release time are data D3, D4, D5. Among these data D3 to D5, the data D4 and D5 satisfy both conditions of the season code C1 and the day of week type code C2.

Data that satisfy the condition of the outside air temperature C4 (23 to 25° C.) are data D6, D7, D8, D9. Among the data D6 to D9, some data of the data D9 satisfy all of the condition of the season code C1, the condition of the day of week type code C2, and the condition of the time C3.

Data that satisfy the condition of the outside air humidity C5 (30 to 50%) are data D10. Some of the data D10 satisfy all of the condition of the season code C1, the condition of the day of week type code C2, the condition of the time C3, and the condition of the outside air temperature C4.

In the example of FIG. 5, data that satisfy all conditions of the parameters C1 to C5 are data D11. The data D11 includes two data, the data of September 18 (Thursday) 16:00 and the data of the same date 17:00. The cold water return temperature prediction unit 106 extracts these two data as the predetermined operation result data similar to the environmental condition at the scheduled heat release time on the operation plan target date for which the cold water return temperature is tried to be predicted.

The cold water return temperature prediction unit 106 uses the cold water return temperatures C6 of these two extracted data to predict the cold water return temperature at the scheduled heat release time on the operation plan target date. The cold water return temperature prediction unit 106, for example, calculates an average value of the cold water return temperatures of the two data, and obtains a value of 9.645° C. (=(10.03+9.26)/2). This 9.645° C. is the cold water return temperature predicted by the cold water return temperature prediction unit 106.

FIG. 6 illustrates an example of a procedure content of cold heat unit price calculation (S12) described in FIG. 3. The operation plan creation unit 108 reads the predicted outside air temperature and predicted outside air humidity at an operation plan target time from the weather data 101, and calculates a wet bulb temperature (S120).

The operation plan creation unit 108 estimates an operation state of each chiller 22, and sets an amount of cold heat and a load factor (S121). At the time of heat storage planning, based on the device specification and device characteristics data 104, the operation plan creation unit 108 assumes a state in which the chiller 22 is operated at the rated load or the most efficient load at each time of the heat storage plan target time. At the time of heat release planning, based on the demand prediction data 103, the operation plan creation unit 108 assumes a state in which the chiller 22 is operated to satisfy the predicted demand amount of cold heat at each time of the heat release plan target time. In this way, the operation plan creation unit 108 sets the amount of cold heat and the load factor for each operation plan target time (S121).

The operation plan creation unit 108 uses a result of warm bulb humidity calculation and energy consumption characteristics included in the device specification and device characteristics data 104, to calculate power consumption at each time (S122). Finally, the operation plan creation unit 108 uses a calculation result of the power consumption and a power unit price included in the device specification and device characteristics data 104 to calculate a power cost at each time, and calculates the cold heat unit price from the calculation result (S123). Here, the cold heat unit price indicates a cost for a unit amount of cold heat. As described above, based on the cold heat unit price at each time, order of priority for determining a heat storage time and a heat release time at the time of operation planning is determined. When there are multiple chillers 22, the device specification and device characteristics data 104 of each chiller 22 is considered.

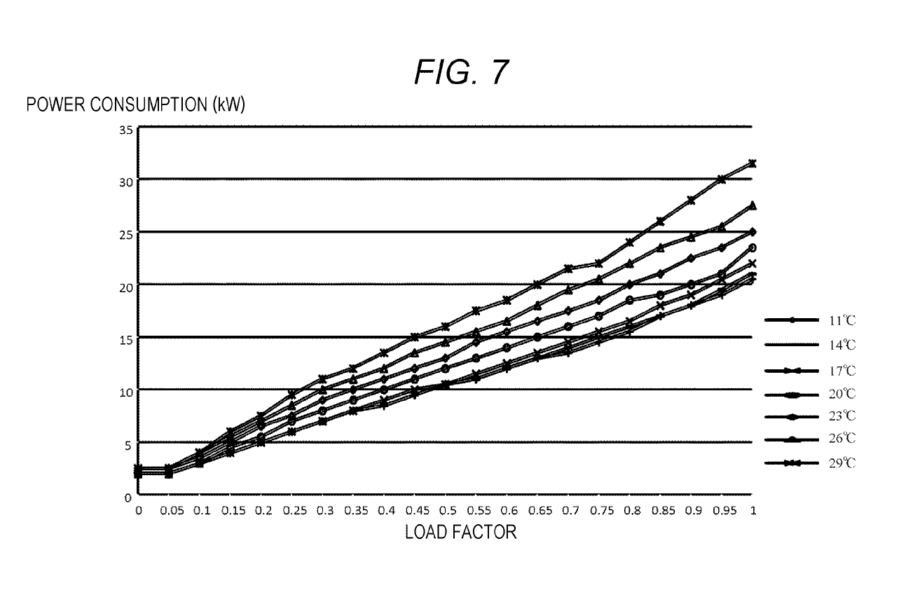

FIG. 7 illustrates an example of power consumption characteristics of the chiller 22. The power consumption characteristics can be used during calculation of the power consumption in step S122 in FIG. 6. In FIG. 7, the vertical axis indicates the power consumption, and the horizontal axis indicates the load factor. Each line graph indicates a wet-bulb temperature. As illustrated in FIG. 7, the power consumption is determined by the load factor for each wet-bulb temperature. The load factor is set in step S121 in FIG. 6, as described above.

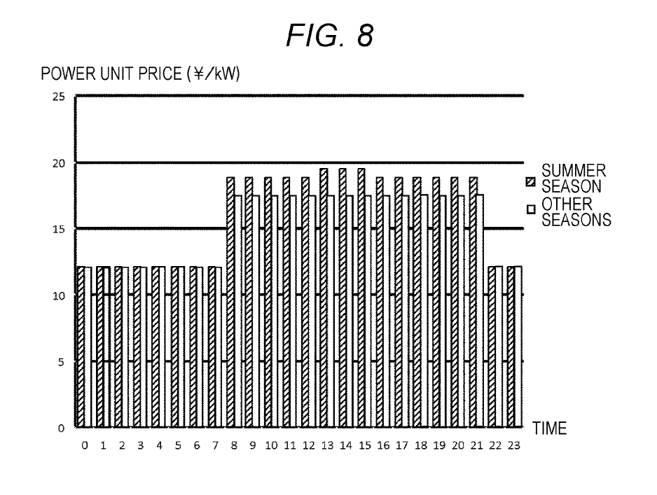

FIG. 8 illustrates an example of the power unit price. The power unit price illustrated in FIG. 8 can be used when the power cost and the cold heat unit price are calculated in step S123 in FIG. 6. In FIG. 8, the vertical axis indicates the power unit price, and the horizontal axis indicates the time. Among bar graphs in FIG. 8, the hatched bar graph indicates the power unit price in a summer season, and the outlined bar graph indicates the power unit price in seasons other than the summer season.

As illustrated in FIG. 8, in general, the power unit price is higher in the summer season, and lower in the other seasons. In addition, in general, the power unit price at nighttime (for example, a time zone from 22:00 to 7:59) is low, and the power unit price at daytime (for example, a time zone from 8:00 to 21:59) is high. Further, in the summer season, the power unit price at a power demand peak time zone (for example, a time zone from 13:00 to 15:59) is particularly high. Incidentally, the graphs illustrated in FIGS. 7 and 8 are examples for understanding the present example, and the present example is not limited to the illustrated examples.

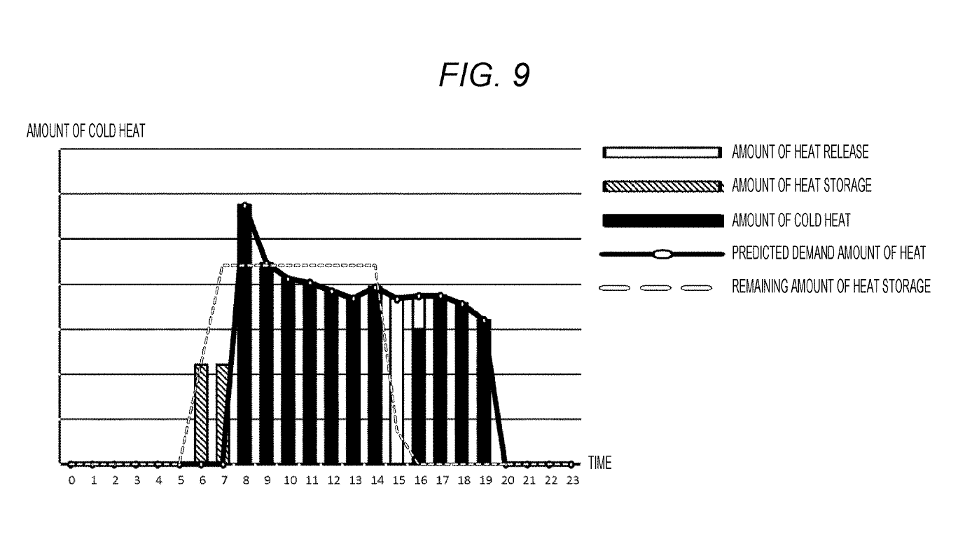

FIG. 9 illustrates an example of the operation plan created by the operation management apparatus 1. In FIG. 9, the vertical axis indicates the amount of cold heat, and the horizontal axis indicate the time. The outlined bar graph indicates the amount of heat release. The black bar graph indicates the amount of cold heat due to operation of the chiller 22. The hatched bar graph indicates the amount of heat storage. The thick polygonal line on which white ellipses are placed indicates the predicted amount of heat demand. The polygonal line indicated as a series of outlined ellipses indicates the remaining amount of heat storage of the heat storage tank 20.

In the heat storage plan, the heat storage capacity estimated by predicting the cold water return temperature is allocated to store heat at the time at which the cold heat unit price is low. In the example of FIG. 9, inexpensive power at 6:00 and 7:00 is used to operate the chiller 22, and heat is stored in the heat storage tank 20.

After the heat storage is completed in the time zone in which the unit price is low, the operation management apparatus 1 operates the chiller 22 in accordance with the predicted amount of heat demand. When the scheduled heat release time set in the heat release plan arrives, the operation management apparatus 1 releases heat from the heat storage tank 20, and shortens the operation time of the chiller 22. In the example of FIG. 9, each of 15:00 and 16:00 at which the cold heat unit price is high is the scheduled heat release time. At the scheduled heat release time, all or some of the predicted amount of heat demand can be satisfied by releasing heat from the heat storage tank 20, and the operation time and the load factor of the chiller 22 can be reduced by that amount.

According to the present example thus configured, it is possible to predict the return temperature Tr of the cold water returning from the air conditioner 3 to the heat source system 2, estimate the heat storage capacity of the heat source system 2, based on the predicted cold water return temperature, and create the operation plan for the heat source system 2, based on the estimated heat storage capacity. Therefore, according to the present example, heat stored in the heat storage tank 20 can be efficiently used.

According to the present example, it is possible to operate the chiller 22 in the time zone in which the cold heat unit price is low to store heat in the heat storage tank 20, and stop or reduce operation of the chiller 22 in the time zone in which the cold heat unit price is high. Therefore, according to the present example, energy saving operation is possible.

Incidentally, the present invention is not limited to the above-described embodiment. Those skilled in the art can perform various additions and modifications within the scope of the present invention. In the example, a case has been described where cold water is supplied to the air conditioner for cooling; however, the present invention can also be applied to heating. In this case, as the heat source device of the heat source system, a hot heat source device such as a boiler or a heat pump may be used. Further, a configuration may be used in which a chiller and a hot heat source device are combined as the heat source device.

### REFERENCE SIGNS LIST

1: heat source system operation management apparatus, 2: heat source system, 3: air conditioning apparatus, 20: heat storage tank, 22: chiller, 24: cold water feed temperature detection unit, 25: cold water return temperature detection unit

1. A heat source system operation management apparatus that is an operation management apparatus for managing operation of a heat source system that supplies a refrigerant to an air conditioner, the apparatus comprising:
a refrigerant return temperature prediction unit that predicts a refrigerant return temperature that is a temperature of the refrigerant returning from the air conditioner to the heat source system;
a heat storage capacity estimation unit that estimates a heat storage capacity of the heat source system, based on the predicted refrigerant return temperature; and
an operation plan creation unit that creates an operation plan for the heat source system, based on the estimated heat storage capacity.

2. The heat source system operation management apparatus according to claim 1, further comprising
an operation control data creation unit that creates operation control data for controlling the operation of the heat source system in accordance with the operation plan created by the operation plan creation unit.

3. The heat source system operation management apparatus according to claim 1, wherein
the heat source system includes:
a heat storage tank that supplies the stored refrigerant to the air conditioner;
a refrigerant generation unit that cools the refrigerant returning from the air conditioner via the heat storage tank, and supplies the cooled refrigerant to the heat storage tank;
a refrigerant feed temperature detection unit that measures and outputs a temperature of the refrigerant fed from the refrigerant generation unit to the heat storage tank; and
a refrigerant return temperature detection unit that measures and outputs a temperature of the refrigerant returning from the heat storage tank to the refrigerant generation unit.

4. The heat source system operation management apparatus according to claim 3, further comprising
an operation result data management unit that manages operation result data indicating a previous operation result of the heat source system, wherein
the operation result data associates at least information on time, information on an environmental condition, and a refrigerant return temperature detected by the refrigerant return temperature detection unit with each other, and
the refrigerant return temperature prediction unit predicts a refrigerant return temperature at a scheduled heat release time on an operation plan date, based on the operation result data.

5. The heat source system operation management apparatus according to claim 4, wherein
the refrigerant return temperature prediction unit
extracts a predetermined number or more of predetermined operation result data in a season identical to a season to which the operation plan date belongs, among the operation result data managed by the operation result data management unit,
calculates an average value of a refrigerant return temperature included in each of the extracted predetermined operation result data, and
performs prediction with the calculated average value as a refrigerant return temperature at the scheduled heat release time on the operation plan date.

6. The heat source system operation management apparatus according to claim 1, wherein
the air conditioner does not include a unit for controlling a temperature of the refrigerant to be returned to the heat source system.

7. A heat source system operation management method that is an operation management method for managing operation of a heat source system that supplies a refrigerant to an air conditioner by using a computer, the method executing:
a refrigerant return temperature prediction step of predicting a refrigerant return temperature that is a temperature of a refrigerant returning from the air conditioner to the heat source system;
a heat storage capacity estimation step of estimating a heat storage capacity of the heat source system, based on the predicted refrigerant return temperature; and
an operation plan creation step of creating an operation plan for the heat source system, based on the estimated heat storage capacity.

8. The heat source system operation management method according to claim 7, wherein
the computer is capable of using operation result data indicating a previous operation result of the heat source system,
the operation result data associates at least information on time, information on an environmental condition, and a refrigerant return temperature actually detected with each other, and
the refrigerant return temperature prediction step predicts a refrigerant return temperature at a scheduled heat release time on an operation plan date, based on the operation result data.

9. The heat source system operation management method according to claim 8, wherein
the refrigerant return temperature prediction step
extracts a predetermined number or more of predetermined operation result data in a season identical to a season to which the operation plan date belongs, among the operation result data,
calculates an average value of a refrigerant return temperature included in each of the extracted predetermined operation result data, and
performs prediction with the calculated average value as a refrigerant return temperature at the scheduled heat release time on the operation plan date.

10. A computer program that causes a computer to function as an operation management apparatus for managing operation of a heat source system that supplies a refrigerant to an air conditioner, the computer program causing the computer to implement:
a refrigerant return temperature prediction unit that predicts a refrigerant return temperature that is a temperature of a refrigerant returning from the air conditioner to the heat source system;
a heat storage capacity estimation unit that estimates a heat storage capacity of the heat source system, based on the predicted refrigerant return temperature; and
an operation plan creation unit that creates an operation plan for the heat source system, based on the estimated heat storage capacity.

11. The computer program according to claim 10, wherein
the heat source system includes:
a heat storage tank that supplies the stored refrigerant to the air conditioner;
a refrigerant generation unit that cools the refrigerant returning from the air conditioner via the heat storage tank, and supplies the cooled refrigerant to the heat storage tank;
a refrigerant feed temperature detection unit that measures and outputs a temperature of the refrigerant fed from the refrigerant generation unit to the heat storage tank; and
a refrigerant return temperature detection unit that measures and outputs a temperature of the refrigerant returning from the heat storage tank to the refrigerant generation unit.
